(19) United States
(12) Patent Application Publication
(10) Pub. No.: US 2024/0257391 A1
(43) Pub. Date: Aug. 1, 2024

(54) INFORMATION PROCESSING APPARATUS AND DEVICE INFORMATION DERIVATION METHOD

(71) Applicant: Sony Interactive Entertainment Inc., Tokyo (JP)

(72) Inventors: Kosuke OMORI, Tokyo (JP); Takanori MINAMINO, Tokyo (JP); Ryotaro YADA, Tokyo (JP)

(73) Assignee: Sony Interactive Entertainment Inc., Tokyo (JP)

(21) Appl. No.: 18/418,390

(22) Filed: Jan. 22, 2024

(30) Foreign Application Priority Data
Jan. 31, 2023 (JP) 2023-012859

(51) Int. Cl. G06T 7/73; A63F 13/211; A63F 13/213; G06T 19/20

(52) U.S. Cl. CPC G06T 7/74; G06T 19/20; A63F 13/211; A63F 13/213; G06T 2207/30204; G06T 2219/2004

(57) ABSTRACT

Provided is an information processing apparatus including a captured image acquisition unit that acquires an image captured of a device including markers, an extraction unit that extracts a marker image coordinate in the captured image, a position and posture derivation unit that derives position information and posture information of the device from the extracted marker image coordinate and a three-dimensional coordinate of a candidate marker in a three-dimensional model of the device by performing a predetermined calculation, and a sensor data acquisition unit. The position and posture derivation unit places the three-dimensional model in a virtual three-dimensional space, and discards or selects the candidate marker to be used for the calculation, on the basis of a difference between an orientation of a surface on which the candidate marker is provided among surfaces of the three-dimensional model and an orientation of a screen surface of the captured image.

### CROSS-REFERENCE TO RELATED APPLICATION

This application claims the benefit of Japanese Priority Patent Application JP 2023-012859 filed Jan. 31, 2023, the entire contents of which are incorporated herein by reference.

### BACKGROUND

The present disclosure relates to an information processing apparatus that derives information regarding a position and posture of a device such as a controller and a device information derivation method.

Japanese Patent Laid-Open No. 2007-296248 discloses a game apparatus that acquires a frame image obtained by capturing an image of the front of the game apparatus, estimates position information and posture information of a game controller in an actual space from a position of a light emitting diode (LED) image of the game controller in the frame image, and reflects the estimated position information and/or posture information on processing of a game application.

### SUMMARY

In recent years, an information processing technology of tracking a position or posture of a device and reflecting the position or posture on a three-dimensional model in a virtual reality (VR) space is widespread. An information processing apparatus operatively associates a movement of a player character or a game object in a game space with a change in a position and posture of a device that is a tracking target, to realize an intuitive operation by a user.

In order to estimate the position and posture of the device, a plurality of light emitting markers are attached to the device. The information processing apparatus specifies coordinates of a plurality of marker images included in an image captured of the device and compares the specified coordinates with three-dimensional coordinates of a plurality of markers in a three-dimensional model of the device to estimate the position and posture of the device in an actual space. Increasing the number of marker images to be captured improves the accuracy of the estimation of the position and posture of the device. However, an increase in the number of marker images results in an increase in the amount of calculation required.

Therefore, it is desirable to provide a technology for reducing the amount of calculation required to estimate a position and posture of a device with high accuracy. It is to be noted that, although the device may be an inputting device including an operation button, the device may be a device that serves as a target of tracking and that does not include an operation member.

According to an embodiment of the present disclosure, there is provided an information processing apparatus including a captured image acquisition unit configured to acquire an image captured of a device that includes a plurality of markers, an extraction unit configured to extract a marker image coordinate in the captured image, a position and posture derivation unit configured to derive position information and posture information of the device from the extracted marker image coordinate and a three-dimensional coordinate of a candidate marker in a three-dimensional model of the device by performing a predetermined calculation, and a sensor data acquisition unit configured to acquire data of a posture sensor of the device, in which the position and posture derivation unit places the three-dimensional model in a virtual three-dimensional space such that the three-dimensional model assumes a provisional posture of the device estimated using the data of the posture sensor, and discards or selects the candidate marker to be used for the calculation, on the basis of a difference between an orientation of a surface on which the candidate marker is provided among surfaces of the three-dimensional model and an orientation of a screen surface of the captured image.

According to another embodiment of the present disclosure, there is provided a device information derivation method including acquiring an image captured of a device that includes a plurality of markers, extracting a marker image coordinate in the captured image, deriving position information and posture information of the device from the extracted marker image coordinate and a three-dimensional coordinate of a candidate marker in a three-dimensional model of the device by performing a predetermined calculation, and acquiring data of a posture sensor of the device, in which the deriving the position information and the posture information includes placing the three-dimensional model in a virtual three-dimensional space such that the three-dimensional model assumes a provisional posture of the device estimated using the data of the posture sensor, and discarding or selecting the candidate marker to be used for the calculation, on the basis of a difference between an orientation of a surface on which the candidate marker is provided among surfaces of the three-dimensional model and an orientation of a screen surface of the captured image.

### BRIEF DESCRIPTION OF THE DRAWINGS

FIG. 1 is a view depicting an example of a configuration of an information processing system according to an embodiment;

FIG. 2 is a view depicting an example of an appearance shape of a head-mounted display (HMD) according to the embodiment;

FIG. 3 is a diagram depicting functional blocks of the HMD according to the embodiment;

FIGS. 4A and 4B are views depicting an appearance shape of an inputting device according to the embodiment;

FIG. 5 is a view depicting an example of part of an image captured of the inputting device in the embodiment;

FIG. 6 is a diagram depicting functional blocks of the inputting device according to the embodiment;

FIG. 7 is a diagram depicting functional blocks of an information processing apparatus according to the embodiment;

FIGS. 8A to 8D are views depicting examples of images captured, by an imaging apparatus according to the embodiment, of the inputting device;

FIG. 9 is a flowchart of an estimation process by an estimation processing unit according to the embodiment;

FIGS. 10A to 10D are views depicting examples of a positional relation of marker image coordinates in the embodiment;

FIGS. 11A and 11B are views for describing a method by which a position and posture derivation unit according to the embodiment discards or selects candidate marker information on the basis of a similarity between a positional relation of marker image coordinates and a positional relation of candidate marker coordinates;

FIGS. 12A and 12B are views for describing how a positional relation between the HMD and the inputting device affects an apparent positional relation of candidate marker coordinates in the embodiment;

FIG. 13 is a view for describing a process by which the position and posture derivation unit according to the embodiment switches rules for selecting candidate marker information on the basis of a direction of the inputting device;

FIG. 14 is a view for describing a method of selecting candidate marker information on the basis of an orientation of a surface of a three-dimensional model of the inputting device on which candidate markers are provided among surfaces of the three-dimensional model and an orientation of a screen surface in the embodiment; and

FIG. 15 is a flowchart depicting a processing procedure by which the position and posture derivation unit selects candidate marker information in step S14 of FIG. 9.

### DETAILED DESCRIPTION OF THE PREFERRED EMBODIMENT

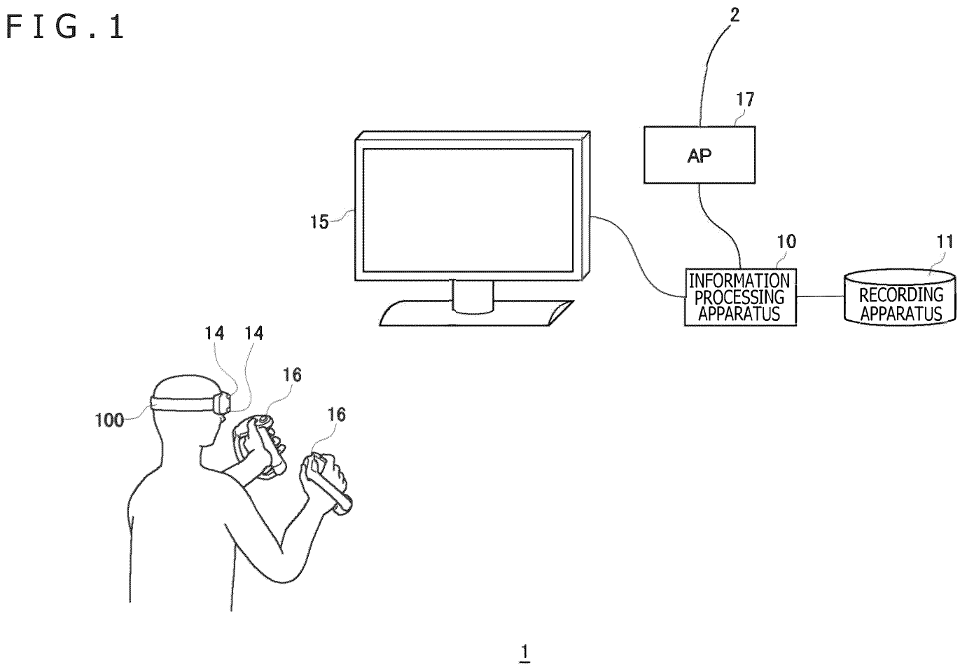

FIG. 1 depicts an example of a configuration of an information processing system 1 according to an embodiment of the present disclosure. The information processing system 1 includes an information processing apparatus 10, a recording apparatus 11, an HMD 100, inputting devices 16, which are operated by a user with fingers of his/her hands, and an outputting apparatus 15, which outputs images and sound. The outputting apparatus may be a television set. The information processing apparatus 10 is connected to an external network 2, such as the Internet, via an access point (AP) 17. The AP 17 has functions of a wireless access point and a router. The information processing apparatus 10 may be connected to the AP 17 by a cable or a known wireless communication protocol.

The recording apparatus 11 records applications of, for example, system software and game software. The information processing apparatus 10 may download game software from a content server to the recording apparatus 11 via the network 2. The information processing apparatus 10 executes the game software and supplies image data and sound data of the game to the HMD 100. The information processing apparatus 10 and the HMD 100 may be connected to each other by a known wireless communication protocol or a cable.

The HMD 100 is a display apparatus that displays an image on a display panel positioned in front of the eyes of the user with the user wearing the HMD 100 on the head. The HMD 100 displays an image for the left eye on a display panel for the left eye and displays an image for the right eye on a display panel for the right eye separately from each other. The images configure parallax images viewed from left and right viewpoints, to implement a stereoscopic vision. Since the user views the display panels through optical lenses, the information processing apparatus 10 supplies parallax image data, which has been subjected to correction of optical distortion caused by the lenses, to the HMD 100.

Although the outputting apparatus 15 is not necessary for the user who wears the HMD 100, providing the outputting apparatus 15 can allow another user to view a display image on the outputting apparatus 15. Although the information processing apparatus 10 may cause the outputting apparatus 15 to display the same image as the image being viewed by the user who wears the HMD 100, the information processing apparatus 10 may cause the outputting apparatus 15 to display a different image. For example, in such a case where the user wearing the HMD 100 and another user play a game together, the outputting apparatus 15 may display a game image from a character viewpoint of the other user.

The information processing apparatus 10 and each of the inputting devices 16 may be connected to each other by a known wireless communication protocol or a cable. Hereinafter, the inputting devices 16 may be collectively referred to as the “inputting device 16.” The inputting device 16 includes a plurality of operation members such as operation buttons, and the user operates the operation members with his/her fingers while gripping the inputting device 16. When the information processing apparatus 10 executes a game, the inputting device 16 is used as a game controller. The inputting device 16 includes a posture sensor including a three-axis acceleration sensor and a three-axis gyro sensor and transmits sensor data in a predetermined cycle such as 1600 Hz to the information processing apparatus 10.

A game according to the present embodiment handles not only operation information of the operation members of the inputting device 16 but also a position, posture, movement, and so forth of the inputting device 16 as operation information and reflects the operation information on a movement of a player character in a virtual three-dimensional space. For example, the operation information of the operation members may be used as information for moving the player character, and the operation information of the position, posture, movement, and so forth of the inputting device 16 may be used as information for moving an arm of the player character. Since, in a battle scene in a game, the movement of the inputting device 16 is reflected on the movement of a player character having a weapon, an intuitive operation by the user is realized, and the immersion in the game is increased.

In order to track the position and posture of the inputting device 16, a plurality of markers as light emitting parts are provided on the inputting device 16 such that images of them can be captured by a plurality of imaging apparatuses 14, which are mounted on the HMD 100. The information processing apparatus 10 analyzes an image captured of the inputting device 16 to estimate position information and posture information of the inputting device 16 in an actual space. The information processing apparatus 10 then provides the estimated position information and posture information to the game.

The HMD 100 includes the plurality of imaging apparatuses 14, which are mounted thereon. The plurality of imaging apparatuses 14 are attached in different postures at different positions of a front surface of the HMD 100 such that a totaling imaging range of imaging ranges of them includes an overall field of view of the user. It is sufficient if the imaging apparatuses 14 are image sensors that can acquire images of the plurality of markers of the inputting device 16. For example, in a case where the markers emit visible light, each imaging apparatus 14 includes a visible light sensor that is used in a general digital video camera such as a charge coupled device (CCD) sensor or a complementary metal oxide semiconductor (CMOS) sensor. In a case where the markers emit invisible light, each imaging apparatus 14 includes an invisible light sensor. The plurality of imaging apparatuses 14 capture an image of the front of the user in a predetermined cycle such as 60 frames per second at synchronized timings and transmit image data obtained by capturing an image of the inputting device 16 to the information processing apparatus 10.

The information processing apparatus 10 specifies positions of the plurality of marker images of the inputting device 16 included in the captured images. Images of a single inputting device 16 may be occasionally captured at the same timing by the plurality of imaging apparatuses 14. Since the attachment position and posture of each imaging apparatus 14 are known, the information processing apparatus 10 synthesizes the plurality of captured images to specify the position of each marker image.

A three-dimensional shape of the inputting device 16 and position coordinates of the plurality of markers arranged on a surface of the inputting device 16 are known, and the information processing apparatus 10 estimates the position coordinate and the posture of the inputting device 16 on the basis of a distribution of the marker images in the captured images. The position coordinate of the inputting device 16 may be a position coordinate in a three-dimensional space having an origin at a reference position. The reference position may be a position coordinate (a latitude and a longitude) set before the game is started.

It is to be noted that the information processing apparatus 10 can also estimate the position coordinate and the posture of the inputting device 16 by using sensor data detected by the posture sensor of the inputting device 16. Therefore, the information processing apparatus 10 according to the present embodiment may perform a process of tracking the inputting device 16 with high accuracy by using an estimation result based on captured images captured by the imaging apparatuses 14 and an estimation result based on the sensor data.

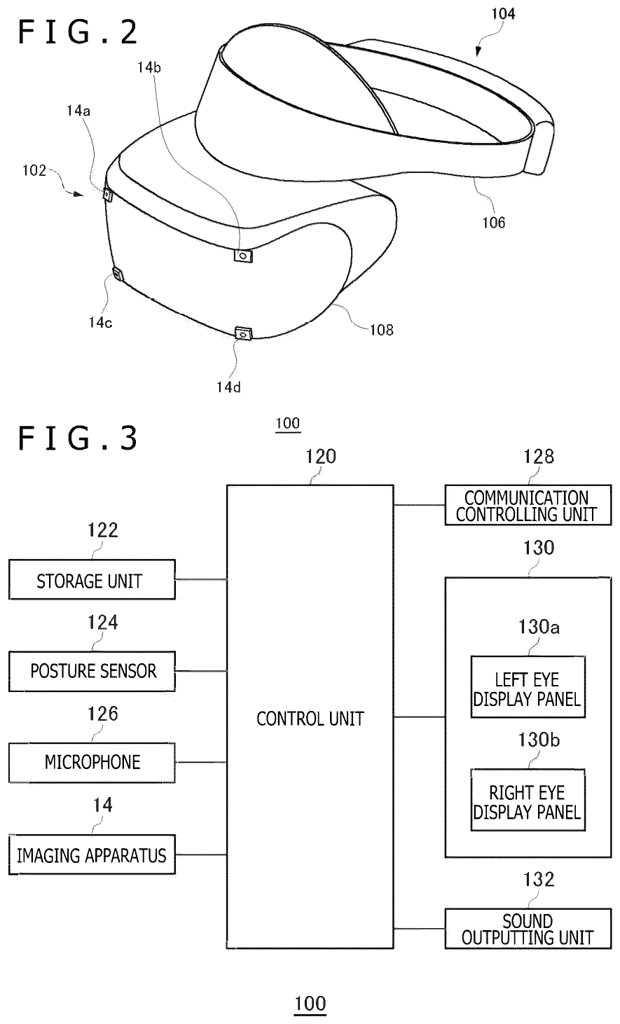

FIG. 2 depicts an example of an appearance shape of the HMD 100. The HMD 100 includes an outputting mechanism unit 102 and a mounting mechanism unit 104. The mounting mechanism unit 104 includes a mounting band 106, which extends, when the HMD 100 is worn by the user, around the head of the user to fix the HMD 100 to the head. The mounting band 106 has a material or a structure that allows adjustment of the length in accordance with the circumference of the head of the user.

The outputting mechanism unit 102 includes a housing 108, which covers the left and right eyes with the user wearing the HMD 100, and includes, in the inside thereof, a display panel that confronts the eyes with the user wearing the HMD 100. The display panel may be, for example, a liquid crystal panel or an organic electroluminescence (EL) panel. The housing 108 further includes, in the inside thereof, a pair of left and right optical lenses that are positioned between the display panel and the eyes of the user and enlarge a viewing angle of the user. The HMD 100 may further include speakers or earphones at positions corresponding to the ears of the user, or external headphones may be connected to the HMD 100.

A plurality of imaging apparatuses 14a, 14b, 14c, and 14d are provided on a front side outer surface of the housing 108. With reference to a gaze direction of the user, the imaging apparatus 14a is attached to an upper right corner of the front side outer surface of the housing 108 such that its camera optical axis points diagonally upward to the right; the imaging apparatus 14b is attached to an upper left corner of the front side outer surface of the housing 108 such that its camera optical axis points diagonally upward to the left; the imaging apparatus 14c is attached to a lower right corner of the front side outer surface of the housing 108 such that its camera optical axis points diagonally downward to the right; and the imaging apparatus 14d is attached to a lower left corner of the front side outer surface of the housing 108 such that its camera optical axis points diagonally downward to the left. The plurality of imaging apparatuses 14 are installed in this manner, so that the totaling imaging range of the imaging ranges of them includes the overall field of view of the user. The field of view of the user may be a field of view of the user in the three-dimensional virtual space. Hereinafter, the imaging apparatuses 14 may be collectively referred to as the “imaging apparatus 14.”

The HMD 100 transmits sensor data detected by the posture sensor and image data captured by the imaging apparatus 14 to the information processing apparatus 10 and receives game image data and game sound data generated by the information processing apparatus 10.

FIG. 3 depicts functional blocks of the HMD 100. A control unit 120 is a main processor that processes and outputs various kinds of data such as image data, sound data, and sensor data and instructions. A storage unit 122 temporarily stores data and instructions to be processed by the control unit 120. A posture sensor 124 acquires sensor data relating to a movement of the HMD 100. The posture sensor 124 includes at least a three-axis acceleration sensor and a three-axis gyro sensor. The posture sensor 124 detects values of individual axial components (sensor data) in a predetermined cycle (e.g., 1600 Hz).

A communication controlling unit 128 transmits, to the external information processing apparatus 10, data outputted from the control unit 120, by wired or wireless communication through a network adapter or an antenna. Further, the communication controlling unit 128 receives data from the information processing apparatus 10 and outputs the data to the control unit 120.

When receiving game image data and game sound data from the information processing apparatus 10, the control unit 120 supplies the game image data to a display panel 130 to cause the display panel 130 to display the game image data thereon, and supplies the sound image data to a sound outputting unit 132 to cause the sound outputting unit 132 to output the sound image data therefrom. The display panel 130 includes a left eye display panel 130a and a right eye display panel 130b such that a pair of parallax images are displayed on the display panels. Further, the control unit 120 causes the communication controlling unit 128 to transmit sensor data from the posture sensor 124, sound data from a microphone 126, and captured image data from the imaging apparatus 14 to the information processing apparatus 10.

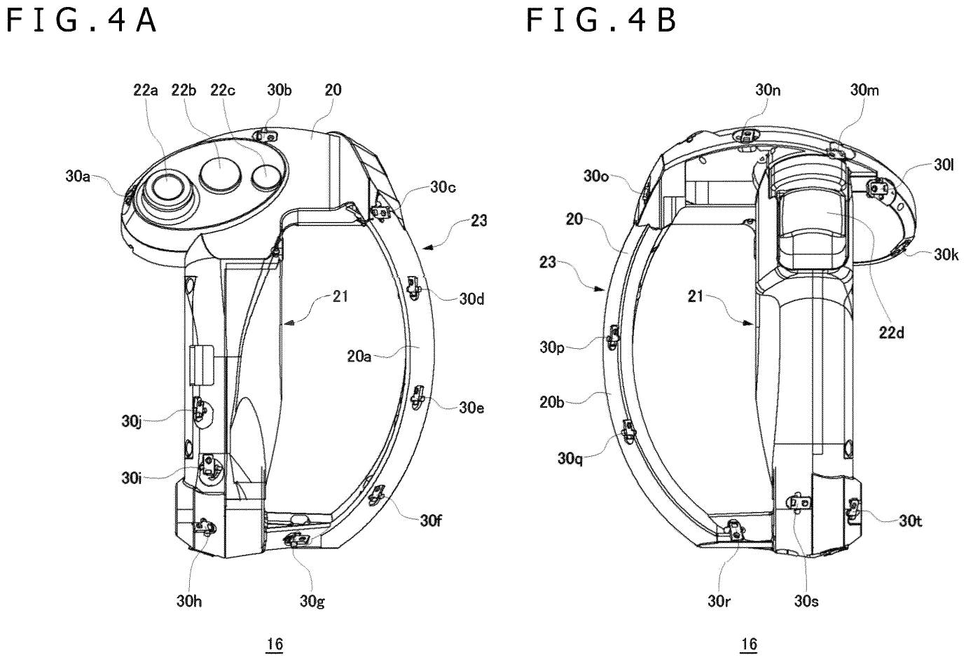

FIGS. 4A and 4B depict an appearance shape of the inputting device 16. In particular, FIG. 4A depicts a front shape of the inputting device 16, and FIG. 4B depicts a rear shape of the inputting device 16. The inputting device 16 includes a case body 20, a plurality of operation members 22a, 22b, 22c, and 22d, which are operated by the user, and a plurality of markers 30a to 30t, which emit light to the outside of the case body 20. In a case where the operation members 22a, 22b, 22c, and 22d do not need to be distinguished from each other, they are referred to as an “operation member 22.” In a case where the markers 30a to 30t do not need to be distinguished from each other, they are referred to as a “marker 30.” The operation member 22 is provided at a head portion of the case body 20 and includes an analog stick provided for tilting operation, a depression button, a trigger button for inputting a pull amount, and so forth.

The case body 20 has a grip part 21 and a curved part 23, which connects a case body head portion and a case body bottom portion to each other. The user passes the fingers from the forefinger to the little finger between the grip part 21 and the curved part 23 and grips the grip part 21. In the state in which the user grips the grip part 21, the user operates the operation members 22a, 22b, and 22c with the thumb and operates the operation member 22d with the forefinger. While the markers 30h, 30i, and 30j are provided on the grip part 21, they are arranged at positions at which they are not hidden by the hand even in the state in which the user grips the grip part 21. Providing one or more markers 30 on the grip part 21 can increase the estimation accuracy of the position and posture of the inputting device 16.

The marker 30 is a light emitting part that emits light to the outside of the case body 20 and includes a resin portion through which light from a light source such as an LED device is diffused and emitted to the outside on a surface of the case body 20. An image of the marker 30 is captured by the imaging apparatus 14 and used in a process of estimating the position and posture of the inputting device 16. Since the imaging apparatus 14 captures an image of the inputting device 16 in a predetermined cycle (e.g., 60 frames per second), it is preferable that the marker 30 emit light in synchronization with periodical imaging timings of the imaging apparatus 14 and be turned off during a non-exposure period of the imaging apparatus 14 to suppress unnecessary power consumption.

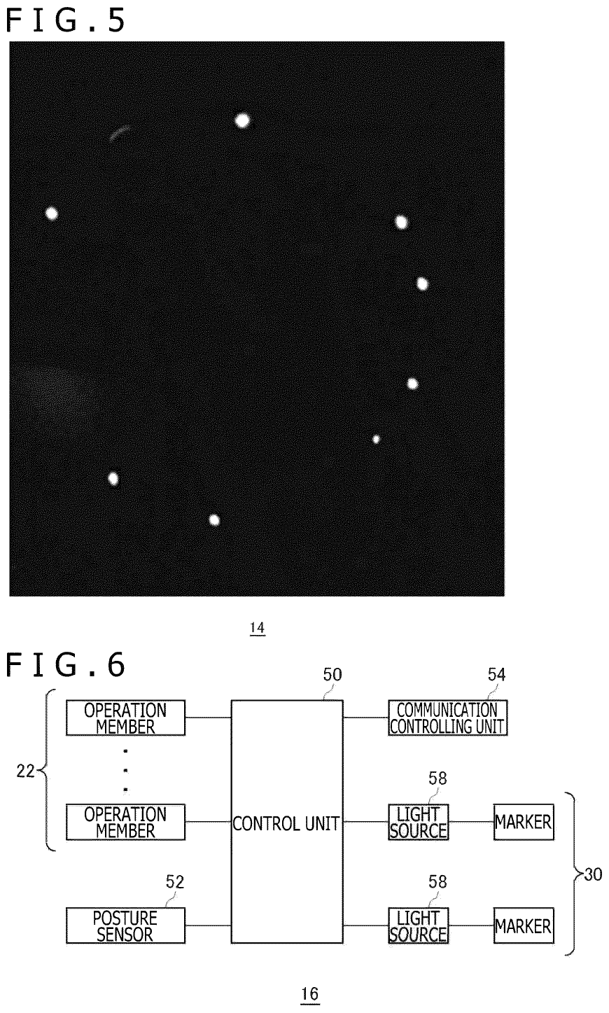

FIG. 5 depicts an example of part of an image captured of the inputting device 16. This image is a captured image of the inputting device 16 gripped by the right hand and includes images of the plurality of markers 30 that emit light. In the HMD 100, the communication controlling unit 128 transmits image data captured by the imaging apparatus 14 to the information processing apparatus 10 in a predetermined cycle.

FIG. 6 depicts functional blocks of the inputting device 16. A control unit 50 accepts operation information inputted to the operation member 22 and accepts sensor data acquired by a posture sensor 52. The posture sensor 52 acquires sensor data relating to a movement of the inputting device 16. The posture sensor 52 includes at least a three-axis acceleration sensor and a three-axis gyro sensor. The posture sensor 52 detects values of individual axial components (sensor data) in a predetermined cycle (e.g., 1600 Hz). The control unit 50 supplies the accepted operation information and sensor data to a communication controlling unit 54. The communication controlling unit 54 transmits, to the information processing apparatus 10, the operation information and sensor data outputted from the control unit 50, by wired or wireless communication through a network adapter or an antenna. Further, the communication controlling unit 54 acquires a light emission instruction from the information processing apparatus 10.

The inputting device 16 includes a plurality of light sources 58, which turn on the plurality of markers 30. The light sources 58 may each be an LED device that emits light of a predetermined color. The control unit 50 causes the light sources 58, on the basis of a light emission instruction acquired from the information processing apparatus 10, to emit light to turn on the markers 30.

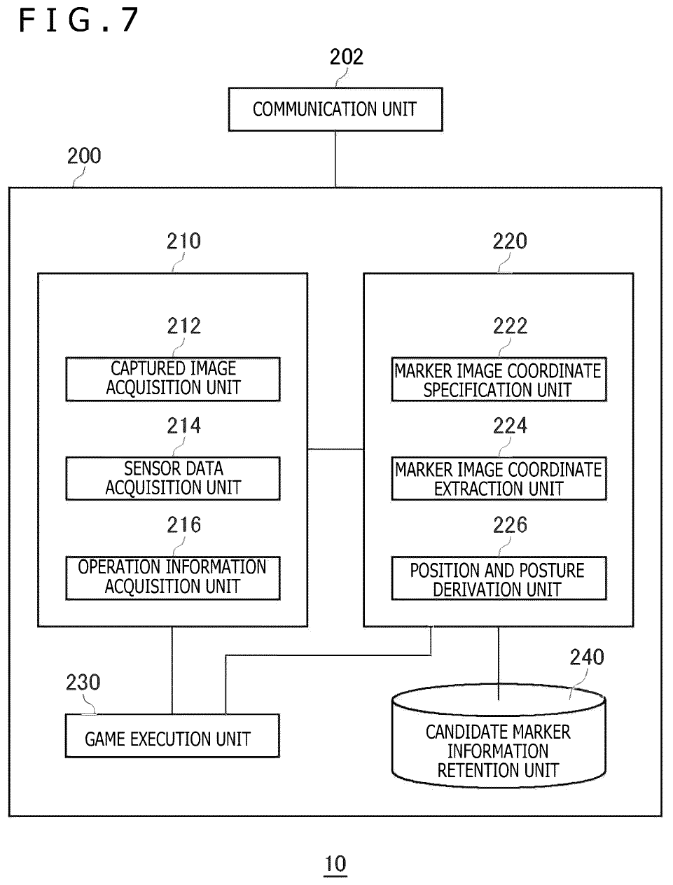

FIG. 7 depicts functional blocks of the information processing apparatus 10. The information processing apparatus 10 includes a processing unit 200 and a communication unit 202. The processing unit 200 includes an acquisition unit 210, an estimation processing unit 220, a game execution unit 230, and a candidate marker information retention unit 240. The communication unit 202 receives operation information and sensor data transmitted from the inputting device 16 and supplies the operation information and the sensor data to the acquisition unit 210. Further, the communication unit 202 receives captured image data and sensor data transmitted from the HMD 100 and supplies the captured image data and the sensor data to the acquisition unit 210.

The acquisition unit 210 includes a captured image acquisition unit 212, a sensor data acquisition unit 214, and an operation information acquisition unit 216. The estimation processing unit 220 includes a marker image coordinate specification unit 222, a marker image coordinate extraction unit 224, and a position and posture derivation unit 226. The estimation processing unit 220 estimates position information and posture information of the inputting device 16 on the basis of marker image coordinates in a captured image. The estimation processing unit 220 supplies the position information and posture information of the inputting device 16 to the game execution unit 230.

These components can be implemented, in terms of hardware, by a freely-selected processor, a memory, and other large scale integration (LSI) circuits and, in terms of software, by a program loaded in the memory and so forth. In FIG. 7, functional blocks implemented by cooperation of them are depicted. Accordingly, it can be recognized by those skilled in the art that the functional blocks can be implemented in various forms only by hardware, only by software, or by a combination of them.

The captured image acquisition unit 212 acquires an image captured of the inputting device 16, which includes the plurality of markers 30, and supplies the image to the estimation processing unit 220. The sensor data acquisition unit 214 acquires sensor data transmitted from the inputting device 16 and the HMD 100 and supplies the sensor data to the estimation processing unit 220. The operation information acquisition unit 216 acquires operation information transmitted from the inputting device 16 and supplies the operation information to the game execution unit 230. The game execution unit 230 proceeds with the game on the basis of the operation information and the position and posture information of the inputting device 16.

The marker image coordinate specification unit 222 specifies a two-dimensional coordinate (hereinafter referred to also as a “marker image coordinate”) that represents an image of each marker 30 included in a captured image. The marker image coordinate specification unit 222 may specify a region of pixels having a luminance value equal to or greater than a predetermined value and calculate and determine a gravity center coordinate of the pixel region as a marker image coordinate. At this time, the marker image coordinate specification unit 222 preferably ignores a pixel region having a shape and a size that cannot be a marker image and calculates a gravity center coordinate of a pixel region having a shape and a size that can be estimated as a marker image.

As a technique for estimating, from a captured image of an object having a known three-dimensional shape and size, a position and posture of the imaging apparatus by which the image of the object has been captured, a method of solving a perspective n-point (PNP) problem is known. In the present embodiment, the marker image coordinate extraction unit 224 extracts N (an integer equal to or greater than three) two-dimensional marker image coordinates in the captured image. Then, the position and posture derivation unit 226 derives position information and posture information of the inputting device 16 from the N marker image coordinates extracted by the marker image coordinate extraction unit 224 and three-dimensional coordinates of N markers in a three-dimensional model of the inputting device 16. The position and posture derivation unit 226 estimates a position and posture of the imaging apparatus 14 with use of the following equation 1 and derives position information and posture information of the inputting device 16 in the three-dimensional space on the basis of the estimation result.

$$\begin{matrix}[ Math . 1 ] & \\ S [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {τ}_{33} & {t}_{3}\end{matrix} ] [ \begin{matrix}X \\ Y \\ Z \\ 1\end{matrix} ] & ( Equation 1 )\end{matrix}$$

Here, (u, v) is a marker image coordinate in the captured image, and (X, Y, Z) is a position coordinate of the marker 30 in the three-dimensional space when the three-dimensional model of the inputting device 16 is in a reference posture at a reference position. It is to be noted that the three-dimensional model is a model that has a completely same shape and size as those of the inputting device 16 and has markers arranged at respective same positions. The candidate marker information retention unit 240 retains three-dimensional coordinates of the individual markers in the three-dimensional model that is in the reference posture at the reference position. The position and posture derivation unit 226 reads out the three-dimensional coordinate of each marker from the candidate marker information retention unit 240 to acquire (X, Y, Z).

In the equation 1 above, (fₓ, f_{y}) is a focal distance of the imaging apparatus 14, (cₓ, c_{y}) is an image principal point, and both of them are internal parameters of the imaging apparatus 14. A matrix whose elements are r₁₁ to r₃₃ and t₁ to t₃ is a rotation and translation matrix. In the equation 1 above, (u, v), (fₓ, f_{y}), (cₓ, c_{y}), and (X, Y, Z) are known, and the position and posture derivation unit 226 solves the equation for the N markers to determine a rotation and translation matrix common to them. The position and posture derivation unit 226 derives the position information and posture information of the inputting device 16 on the basis of the angle and a translation amount represented by the matrix. In the present embodiment, the process of estimating the position and posture of the inputting device 16 is performed by solving the P3P problem. Accordingly, the position and posture derivation unit 226 derives the position and posture of the inputting device 16 by using three marker image coordinates and three three-dimensional marker coordinates of the three-dimensional model of the inputting device 16.

The inputting device 16 according to the present embodiment includes 20 or more markers 30, and the number of combinations of N marker image coordinates is huge. Therefore, in the present embodiment, the position and posture derivation unit 226 solves the PNP problem by performing a process of extracting N marker image coordinates with use of a predetermined extraction criterion and collating the extracted N marker image coordinates with a combination of the predetermined number N of three-dimensional marker coordinates. This reduces unnecessary calculation by the position and posture derivation unit 226 and realizes an estimation process with high efficiency and high accuracy.

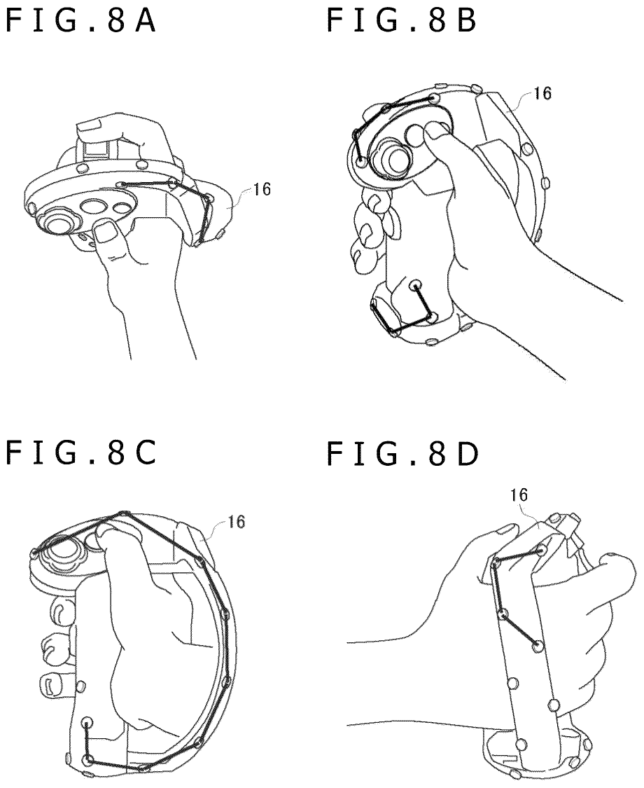

FIGS. 8A to 8D depict examples of images captured, by the imaging apparatus 14 from various angles, of the inputting device 16. FIGS. 8A to 8D depict arrangement patterns in which, when marker images positioned close to each other are connected to each other by a line segment and four marker images are successively connected to each other by line segments, angles formed by adjacent line segments become obtuse angles in the same orientation.

The inventors of the present disclosure actually produced a prototype of the inputting device 16 in which 23 markers 30 were arranged, and checked the number of combinations of four markers 30 whose images might possibly be captured such that the angles formed by adjacent line segments all became obtuse angles in the same orientation. The number of combinations was 29. Naturally, the number of combinations of four markers 30 whose angles formed by adjacent line segments are all obtuse angles varies depending on the shape of the inputting device 16 and the positions of the markers 30. In any case, four markers 30 whose angles formed by adjacent line segments are all obtuse angles are specified according to the shape of the inputting device 16 and the positions of the markers 30.

Therefore, in the present embodiment, the candidate marker information retention unit 240 retains, as candidate marker information, combinations of three three-dimensional coordinates from among four markers 30 whose angles formed by adjacent line segments are all obtuse angles, and the position and posture derivation unit 226 then performs calculation of the equation 1 with use of the candidate marker information. In the present embodiment, the number of combinations of four markers 30 whose angles formed by adjacent line segments are all obtuse angles is M, and accordingly, the candidate marker information retention unit 240 retains M pieces of candidate marker information. It is to be noted that, since the inputting device 16 may be provided for each of the right hand and the left hand, the candidate marker information retention unit 240 may retain M pieces of candidate marker information for the right hand and M pieces of candidate marker information for the left hand.

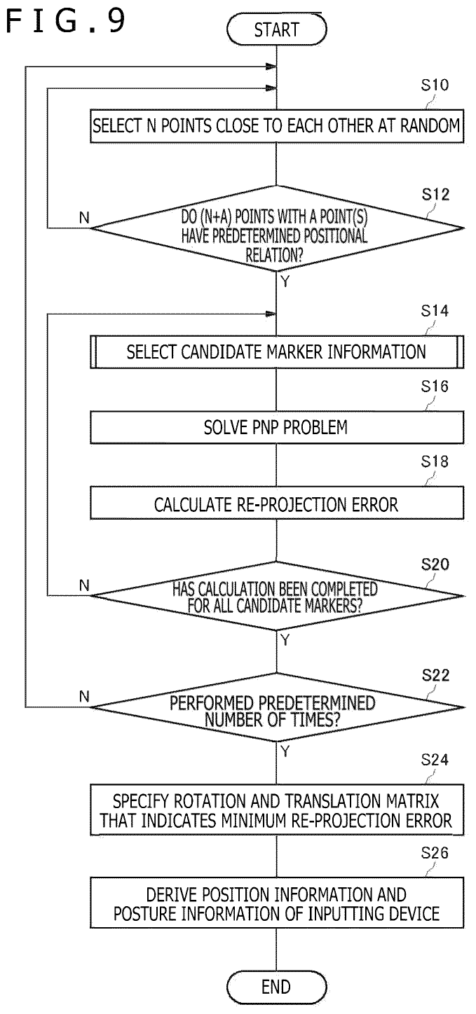

FIG. 9 is a flowchart of the estimation process by the estimation processing unit 220. After the marker image coordinate specification unit 222 specifies coordinates of marker images (marker image coordinates) included in a captured image, the marker image coordinate extraction unit 224 selects, at random, N (an integer equal to or greater than three) marker image coordinates located close to each other (S10). At this time, the marker image coordinate extraction unit 224 may select one marker image coordinate at random and specify (N−1) marker image coordinates close to the selected marker image coordinate, thereby selecting totaling N marker image coordinates located close to each other.

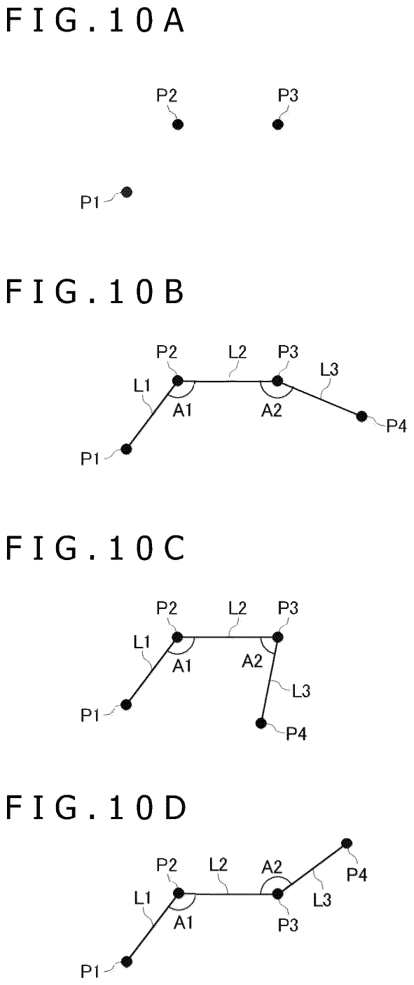

FIG. 10A depicts an example of a positional relation of the selected N marker image coordinates. In the present embodiment, the marker image coordinate extraction unit 224 orders the selected N marker image coordinates in the clockwise direction. In the present embodiment, N=3, and the marker image coordinate extraction unit 224 defines the extracted three marker image coordinates as a “first marker image coordinate P1,” a “second marker image coordinate P2,” and a “third marker image coordinate P3.” It is to be noted that the ordering method is not limited to ordering in the clockwise direction. In any case, the selected three marker image coordinates are actual coordinates (u, v) to be inputted when the equation of the PNP problem is solved, provided that the extraction criterion in step S12 is satisfied.

The marker image coordinate extraction unit 224 further selects A (an integer equal to or greater than one) marker image coordinate (s). The marker image coordinate extraction unit 224 selects A marker image coordinate (s) in the proximity of the third marker image coordinate P3 to which the last order number is assigned. Accordingly, the marker image coordinate extraction unit 224 selects totaling (N+A) marker image coordinates.

In a case where (N+A) marker image coordinates have a predetermined positional relation, the marker image coordinate extraction unit 224 extracts N marker image coordinates from among the (N+A) marker image coordinates as marker image coordinates (u, v) to be substituted into the equation 1 by the position and posture derivation unit 226. That the (N+A) marker image coordinates have the predetermined positional relation is defined as an extraction criterion of the N marker image coordinates by the marker image coordinate extraction unit 224.

In the present embodiment, A=1. The marker image coordinate extraction unit 224 checks whether or not the selected four marker image coordinates satisfy the extraction criterion, in other words, whether or not they have the predetermined positional relation. Here, the predetermined positional relation is a relation that, when the (N+A) marker image coordinates are connected to each other by a plurality of line segments continuing to each other, angles formed by adjacent line segments all become obtuse angles. FIG. 10B depicts an example of an arrangement pattern that satisfies the extraction criterion, and FIGS. 10C and 10D depict examples of an arrangement pattern that does not satisfy the extraction criterion.

FIG. 10B depicts an example of the arrangement pattern of the selected (N+A) marker image coordinates. In the following description, a fourth marker image coordinate is referred to as a “fourth marker image coordinate P4.” A line segment that connects the first marker image coordinate P1 and the second marker image coordinate P2 is referred to as a “first line segment L1”; a line segment that connects the second marker image coordinate P2 and the third marker image coordinate P3 is referred to as a “second line segment L2”; and a line segment that connects the third marker image coordinate P3 and the fourth marker image coordinate P4 is referred to as a “third line segment L3.” Further, an angle formed by the first line segment L1 and the second line segment L2 is referred to as a “first angle A1,” and an angle formed by the second line segment L2 and the third line segment L3 is referred to as a “second angle A2.”

In a case where the first angle A1 and the second angle A2 are obtuse angles, the marker image coordinate extraction unit 224 determines that the four marker image coordinates satisfy the extraction criterion, in other words, they have the predetermined positional relation (Y in S12). More strictly, in a case where the first angle A1 and the second angle A2 are interior angles and are also obtuse angles in a quadrangle formed by the first line segment L1, the second line segment L2, the third line segment L3, and a line segment connecting the fourth marker image coordinate P4 and the first marker image coordinate P1, the marker image coordinate extraction unit 224 determines that the four marker image coordinates have the predetermined positional relation. At this time, the marker image coordinate extraction unit 224 supplies the combination of the first marker image coordinate P1, the second marker image coordinate P2, and the third marker image coordinate P3 to the position and posture derivation unit 226.

FIG. 10C depicts another example of the arrangement pattern of the selected (N+A) marker image coordinates. In this arrangement pattern, the second angle A2 is an acute angle, and the marker image coordinate extraction unit 224 determines that the first marker image coordinate P1, the second marker image coordinate P2, and the third marker image coordinate P3 do not satisfy the extraction criterion (N in S12). Therefore, the marker image coordinate extraction unit 224 discards the combination of the first marker image coordinate P1, the second marker image coordinate P2, and the third marker image coordinate P3 without supplying the combination to the position and posture derivation unit 226, and returns the processing to step S10, in which the marker image coordinate extraction unit 224 selects different three marker image coordinates.

FIG. 10D depicts still another example of the arrangement pattern of the selected (N+A) marker image coordinates. In this arrangement pattern, although the second angle A2 is an obtuse angle, the first line segment L1, the second line segment L2, the third line segment L3, and the line segment connecting the fourth marker image coordinate P4 and the first marker image coordinate P1 do not form a quadrangle, or even in a case where a quadrangle is formed, at least one of the first angle A1 and the second angle A2 does not become an interior angle. Therefore, the marker image coordinate extraction unit 224 determines that the first marker image coordinate P1, the second marker image coordinate P2, and the third marker image coordinate P3 do not satisfy the extraction criterion (N in S12). Therefore, the marker image coordinate extraction unit 224 discards the combination of the first marker image coordinate P1, the second marker image coordinate P2, and the third marker image coordinate P3 without supplying the combination to the position and posture derivation unit 226, and returns the processing to step S10, in which the marker image coordinate extraction unit 224 selects different three marker image coordinates.

It is to be noted that the arrangement patterns depicted in FIGS. 10B to 10D assume that the first angle A1 is an obtuse angle. In a case where adjacent line segments each connecting two points of the first marker image coordinate P1, the second marker image coordinate P2, and the third marker image coordinate P3 cannot form an obtuse angle, the marker image coordinate extraction unit 224 discards such a combination and selects three new marker image coordinates.

There is a high possibility that the combination of the first marker image coordinate P1, the second marker image coordinate P2, and the third marker image coordinate P3 that satisfy the extraction condition corresponds to one of combinations of three three-dimensional coordinates specified from the M pieces of candidate marker information retained by the candidate marker information retention unit 240. Since the marker image coordinate extraction unit 224 extracts, using the extraction condition, three pieces of marker image information having a high possibility that they match candidate marker information specified in advance, the estimation process is realized by the position and posture derivation unit 226 with high efficiency and high accuracy.

The candidate marker information retention unit 240 retains, as candidate marker information, a combination of at least N three-dimensional coordinates from among the three-dimensional coordinates of (N+A) markers that satisfy the predetermined positional relation. As described above, in the present embodiment, the candidate marker information retention unit 240 retains M pieces of candidate marker information. The position and posture derivation unit 226 selects one piece of candidate marker information from among pieces of candidate marker information that may possibly correspond to the N marker images extracted through steps S10 and S12, from among the M pieces of candidate marker information retained by the candidate marker information retention unit 240 (S14), solves the PNP problem with use of the equation 1 (S16), and calculates a re-projection error (S18).

The position and posture derivation unit 226 repeats steps S14 to S18 until completion of the calculation for all the pieces of candidate marker information that may possibly correspond to the marker images extracted from the captured image, from among the M pieces of candidate marker information retained by the candidate marker information retention unit 240 (N in S20). When the position and posture derivation unit 226 has calculated a re-projection error in regard to these pieces of candidate marker information (Y in S20), the position and posture derivation unit 226 ends the estimation calculation for the one combination of the first marker image coordinate P1, the second marker image coordinate P2, and the third marker image coordinate P3.

The position and posture derivation unit 226 performs the estimation calculation for a plurality of combinations of the first marker image coordinate P1, the second marker image coordinate P2, and the third marker image coordinate P3 (N in S22), and when the number of such combinations for which the estimation calculation has been performed has reached a predetermined number (Y in S22), the position and posture derivation unit 226 specifies a rotation and translation matrix that indicates a minimum re-projection error (S24), and derives position information and posture information of the inputting device 16 (S26). The position and posture derivation unit 226 supplies the derived position information and posture information to the game execution unit 230.

Next, a method by which the position and posture derivation unit 226 selects, in step S14, candidate marker information that may possibly correspond to the N marker images extracted through steps S10 and S12, from among the M pieces of candidate marker information retained by the candidate marker information retention unit 240 is described. The position and posture derivation unit 226 appropriately selects candidate marker information that is highly likely to correspond to the marker images and then uses the selected candidate marker information in steps S16 and S18, so that the number of times those steps are performed can be reduced and processing efficiency can be dramatically increased.

Specifically, the position and posture derivation unit 226 uses the sensor data of the posture sensor 124 of the HMD 100 and the posture sensor 52 of the inputting device 16 to evaluate states of candidate markers visible from the HMD 100, so that candidate marker information that does not clearly correspond to the marker images is not used for the calculation in step S16. The following exemplifies a rule for selecting candidate marker information with use of the sensor data.

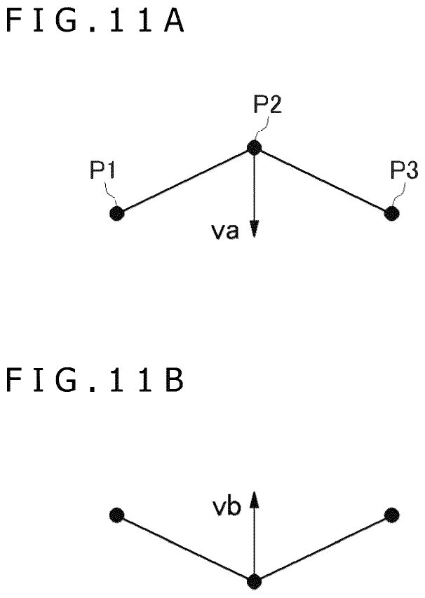

FIGS. 11A and 11B are views for describing a method by which the position and posture derivation unit 226 discards or selects candidate marker information on the basis of a similarity between a positional relation of N marker image coordinates and a positional relation of N candidate marker coordinates. Specifically, FIG. 11A depicts an example of a positional relation of three marker image coordinates. The marker image coordinates are extracted through steps S10 and S12 of FIG. 9. In this example, N=3.

FIG. 11B depicts an example of an apparent positional relation of N (=3) marker coordinates (hereinafter referred to as “candidate marker coordinates”) included in candidate marker information when provisional postures of the HMD 100 and the inputting device 16 are estimated on the basis of sensor data and the three-dimensional model is controlled to have the same posture in a virtual three-dimensional space. In other words, FIG. 11B exemplifies the arrangement of the candidate marker coordinates when the three-dimensional model of the inputting device 16 is viewed from the HMD 100 in the virtual three-dimensional space.

The position and posture derivation unit 226 evaluates a similarity between a positional relation (pattern) of the marker image coordinates actually observed, as illustrated in FIG. 11A, and a positional relation (pattern) of the candidate marker coordinates when the posture of the three-dimensional model of the inputting device 16 is assumed and the three-dimensional model thereof is viewed from the HMD 100, as illustrated in FIG. 11B. For example, the position and posture derivation unit 226 evaluates the similarity on the basis of a direction in which an obtuse angle formed by line segments each connecting adjacent coordinates is formed in each pattern.

In the example depicted in FIG. 11A, the first marker image coordinate P1, the second marker image coordinate P2, and the third marker image coordinate P3 have such a positional relation that the obtuse angle formed by the line segments connecting them is directed toward a lower side of a paper surface. On the other hand, in the example depicted in FIG. 11B, the three candidate marker coordinates have such a positional relation that the obtuse angle formed by the line segments connecting them is directed toward an upper side of the paper surface. In this case, the position and posture derivation unit 226 determines that the similarity between the combination of the candidate marker coordinates and the combination of the marker image coordinates is low and the combination of the candidate marker coordinates does not correspond to the combination of the marker image coordinates.

For example, the position and posture derivation unit 226 acquires vectors va and vb as directions in which the respective obtuse angles are directed. Each of the vectors va and vb has a start point at a vertex of the obtuse angle formed by the corresponding combination of coordinates and bisects the obtuse angle. In a case where an angular difference between the vector va acquired from the combination of the marker image coordinates and the vector vb acquired from the combination of the candidate marker coordinates is equal to or greater than a predetermined value, the position and posture derivation unit 226 determines that the candidate marker information does not correspond to the marker image coordinates and excludes the candidate marker information from the calculation process to be performed later. The predetermined angle is, for example, 90°.

The selection of the candidate marker information based on the similarity of the positional relations of the coordinates as described above is based on the assumption that the apparent positional relation of the candidate marker coordinates, and by extension, the vector vb, does not change significantly even if a provisional posture given to the three-dimensional model of the inputting device 16 has some errors to some extent. However, depending on the positional relation between the HMD 100 and the inputting device 16 in the three-dimensional space, errors in the posture of the three-dimensional model may significantly affect the apparent positional relation of the candidate marker coordinates, making it difficult to accurately discard or select candidate marker information.

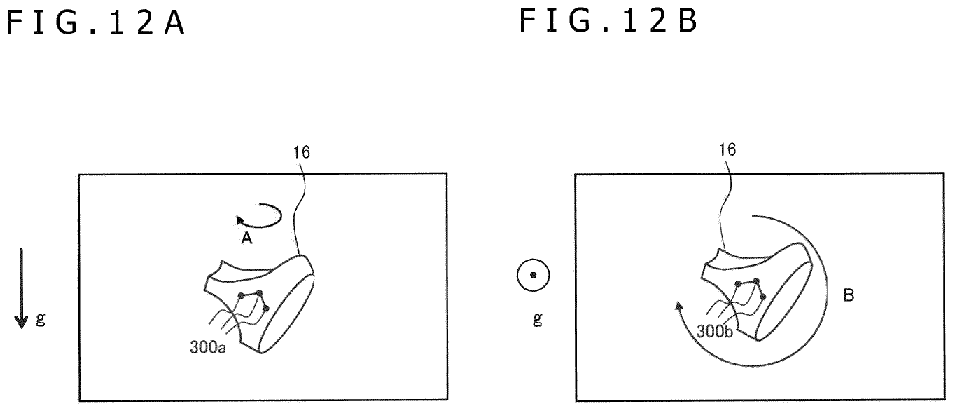

FIGS. 12A and 12B are views for describing how the positional relation between the HMD 100 and the inputting device 16 affects an apparent positional relation of candidate marker coordinates. FIGS. 12A and 12B each depict a state of the three-dimensional model of the inputting device 16 in the virtual three-dimensional space when viewed from the HMD 100 side. As described above, a provisional posture including an inclination with respect to a gravity direction g is set to the three-dimensional model of the inputting device 16 on the basis of the sensor data from the posture sensor. The provisional posture can naturally include some errors. In FIG. 12A, the gravity direction g is directed toward a lower side of a paper surface. This situation is achieved when, for example, the inputting device 16 is in a direction close to horizontal to the HMD 100. In this case, for example, as indicated by an arrow A, even if a rotation angle around the gravity direction g has many errors, a positional relation of candidate marker coordinates 300a viewed from the HMD 100 does not change to the extent that the determination criterion using the similarity described above become invalid. More specifically, a direction of an obtuse angle formed by line segments each connecting adjacent candidate marker coordinates does not change beyond 90°. In other words, in this situation, the accuracy of discarding or selecting the candidate markers based on the similarity of the positional relations of the coordinates is highly robust against errors included in the provisional posture.

In FIG. 12B, an axis that is perpendicular to a paper surface and that points toward the front is assumed to be the gravity direction g. This situation is achieved when the inputting device 16 is in an approximately vertically upward direction with respect to the HMD 100. In this case, for example, a rotation around the gravity direction g indicated by an arrow B directly affects and changes a positional relation of candidate marker coordinates 300b viewed from the HMD 100. More specifically, a direction of an obtuse angle formed by line segments each connecting adjacent candidate marker coordinates changes with the rotation of the inputting device 16. Therefore, there is a high possibility that candidate marker information is not appropriately discarded or selected due to errors included in the provisional posture.

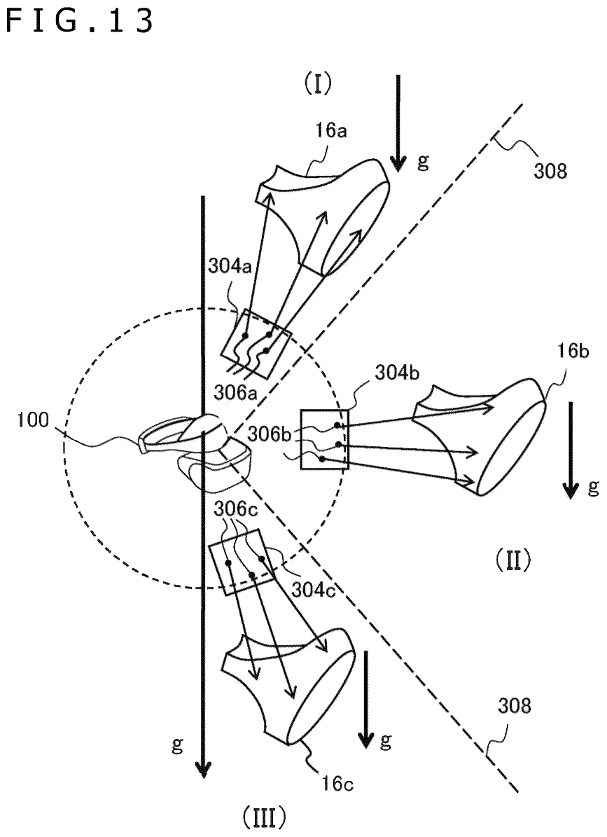

Therefore, the position and posture derivation unit 226 switches the rules for selecting candidate marker information, according to a direction of the inputting device 16 with respect to the HMD 100. FIG. 13 is a view for describing a process by which the position and posture derivation unit 226 switches the rules for selecting candidate marker information, on the basis of the direction of the inputting device 16. FIG. 13 represents states at the same time in which the inputting device 16 is in an upper region (I), a horizontal region (II), and a lower region (III) of the HMD 100 in the three-dimensional space where the gravity direction g is directed toward a lower side of a paper surface.

For example, when a user's face, and by extension, the front of the HMD 100, is facing upward, marker images 306a of an inputting device 16a in the upper region (I) appear near a center of a screen surface 304a of the imaging apparatus 14. When the front of the HMD 100 is facing in a horizontal direction, marker images 306b of an inputting device 16b in the horizontal region (II) appear near a center of a screen surface 304b corresponding to an imaging surface of the imaging apparatus 14. When the front of the HMD 100 is facing downward, marker images 306c of an inputting device 16c in the lower region (III) appear near a center of a screen surface 304c corresponding to the imaging surface of the imaging apparatus 14.

In actual implementation, however, an angle of view of the imaging apparatus 14 may be wider than the one depicted in FIG. 13, and the marker images of the inputting device 16 located above or below the HMD 100 may appear even when the front of the HMD 100 is facing in the horizontal direction. The screen surface is a virtual surface of the imaging apparatus 14 onto which images are projected, and a shape of the screen surface may vary depending on a projection method. In any case, postures of the screen surfaces 304a, 304b, and 304c are determined on the basis of the posture of the HMD 100 indicated by sensor data, and the direction of the markers with respect to the HMD 100, and by extension, the direction of the inputting device 16 is calculated by a known coordinate transformation using camera parameters, on the basis of the position coordinates of the marker images on the screen surface.

The state of the inputting device 16b in the horizontal region (II) corresponds to FIG. 12A. In other words, the positional relation of the candidate marker coordinates does not change significantly with respect to errors in the provisional posture of the three-dimensional model corresponding to the inputting device 16b. Therefore, the accuracy of the selection of candidate marker information based on the similarity with the pattern of the marker image coordinates is highly robust. The state in which the inputting device 16a is in the upper region (I) corresponds to FIG. 12B. In other words, the positional relation of the candidate marker coordinates visible from the HMD 100 changes significantly depending on the rotation angle around the gravity direction g. Therefore, the accuracy of the selection of candidate marker information is likely to deteriorate if the selection is made on the basis of the similarity with the pattern of the marker image coordinates.

Similarly, when the inputting device 16c is in the lower region (III), the positional relation of the candidate marker coordinates viewed from the HMD 100 changes significantly depending on the rotation angle around the gravity direction g. Therefore, the accuracy of the selection of candidate marker information is likely to deteriorate if the selection is made on the basis of the similarity with the pattern of the marker image coordinates. Accordingly, the position and posture derivation unit 226 quantifies the direction of the inputting device 16 with respect to the HMD 100 by an angle from an axis of the gravity direction g and switches the rules for selecting candidate markers, according to the region to which the angle belongs.

Specifically, in a case where the angle of the inputting device 16 with respect to the axis of the gravity direction g exceeds a predetermined boundary 308, the position and posture derivation unit 226 discards or selects candidate marker information on the basis of the similarity between the positional relation of the candidate marker coordinates and the positional relation of the marker image coordinates, as depicted in FIGS. 11A and 11B. In a case where the angle of the inputting device 16 with respect to the axis of the gravity direction g does not exceed the predetermined boundary 308, the position and posture derivation unit 226 determines that the inputting device 16 is in the upper region (I) or the lower region (III). In this case, the position and posture derivation unit 226 discards or selects candidate marker information on a basis other than the similarity between the positional relation of the candidate marker coordinates and the positional relation of the marker image coordinates.

The boundary 308 representing an angle with respect to the axis of the gravity direction g is, for example, 30°. This setting corresponds to an elevation angle of 60° with reference to a horizontal plane. The position and posture derivation unit 226 acquires the angle of the inputting device 16 with respect to the axis of the gravity direction g on the basis of the direction of a vector obtained by averaging three-dimensional vectors representing the directions when the marker image coordinates (the marker images 306a, 306b, and 306c) are back-projected into the three-dimensional space.

As a basis for discarding or selecting candidate marker information when the inputting device 16 belongs to the upper region (I) or the lower region (III), the position and posture derivation unit 226 checks whether or not a surface of the three-dimensional model of the inputting device 16 on which the candidate markers are provided among surfaces of the three-dimensional model is visible from the HMD 100, and by extension, the screen surface corresponding to the imaging surface, on the basis of the direction in which both surfaces face. In a case where the surface on which the candidate markers are provided is inclined such that the surface is not visible from the screen surface, the position and posture derivation unit 226 determines that images of the candidate markers cannot be captured in a captured image and excludes corresponding candidate marker information from a selection target.

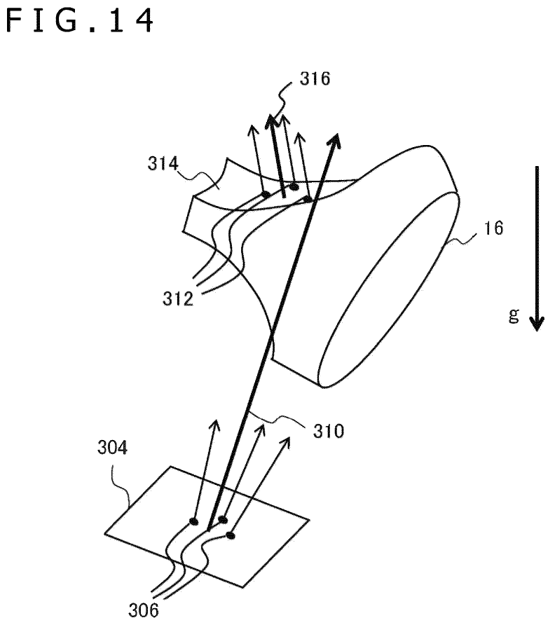

FIG. 14 is a view for describing a method of selecting candidate marker information on the basis of an orientation of a surface of the three-dimensional model of the inputting device 16 on which candidate markers are provided among the surfaces of the three-dimensional model and an orientation of the screen surface. FIG. 14 assumes a case in which the inputting device 16 is in the upper region of the HMD 100. That is, when marker images 306 extracted on a screen surface 304 of a captured image are back-projected into the three-dimensional space, a direction of an average vector 310 (hereinafter referred to as a “marker image average vector 310”) of three-dimensional vectors representing their respective directions is in a range defined as the upper region.

As in the case of FIGS. 11A and 11B, the position and posture derivation unit 226 places, in the virtual three-dimensional space, the three-dimensional model of the inputting device 16 in a provisional posture based on sensor data. For clarity, in FIG. 14, the three-dimensional model of the inputting device 16 is depicted with respect to the screen surface 304. However, an actual position may be undetermined. The position and posture derivation unit 226 determines whether or not images of candidate markers 312 can be captured in a captured image, on the basis of a difference between an orientation of the screen surface 304 of the captured image and an orientation of a surface 314 of the three-dimensional model on which the candidate markers 312 are provided among the surfaces of the three-dimensional model.

When the surface on which the candidate markers 312 are provided is in front of the screen surface 304, the orientations of the two surfaces are in opposite directions, that is, the difference between the orientations of the surfaces is 180º. When the difference between the two surfaces approaches 90°, the inclination of the surface on which the candidate markers 312 are provided becomes steeper with respect to the screen surface 304, and an image of a pattern of the candidate marker coordinates becomes more difficult to be captured. When the difference between the two surfaces is within 90°, the surface on which the candidate markers 312 are provided is on a back side (rear side) when viewed from the screen surface 304, and thus, images of the candidate markers 312 cannot be captured in a captured image.

This characteristic is maintained even if the three-dimensional model of the inputting device 16 is rotated around the gravity direction g. Therefore, it can be said that the method of discarding or selecting candidate markers on the basis of the difference between the orientation of the surface on which the candidate markers 312 are provided and the orientation of the screen surface is robust against errors in direction parameters that define a provisional posture. In the example depicted in FIG. 14, the difference between the orientation of the surface 314 on which the candidate markers 312 are provided and the orientation of the screen surface 304 is smaller than 90°, and it is determined that images of the candidate markers 312 cannot be captured in a captured image.

The position and posture derivation unit 226 actually evaluates the difference between the orientation of the surface 314 and the orientation of the screen surface 304 according to an angular difference between an average vector 316 (hereafter referred to as a “candidate marker average vector 316”) of normal vectors of the candidate markers 312 and the marker image average vector 310. By using the candidate marker average vector 316, even if the surface 314 is a curved surface, the position and posture derivation unit 226 can determine whether or not the surface 314 is oriented such that images of the candidate markers 312 are captured in a captured image, by limiting a target region to a region where the candidate markers 312 are distributed. Further, by using the marker image average vector 310, even if the screen surface 304 is a curved surface due to a fisheye lens or the like, the position and posture derivation unit 226 can specify the orientation of the screen surface by limiting a target region to a region where images of the markers are captured.

The difference between orientations of surfaces, that is, the angular difference between the candidate marker average vector 316 and the marker image average vector 310, where images of the candidate markers 312 cannot be captured in a captured image is typically within 90°. However, a threshold angle may be determined as appropriate taking into account the shape of the surface of the inputting device 16, the shape of the screen surface, errors in the posture of the three-dimensional model with respect to the gravity direction g, and so forth.

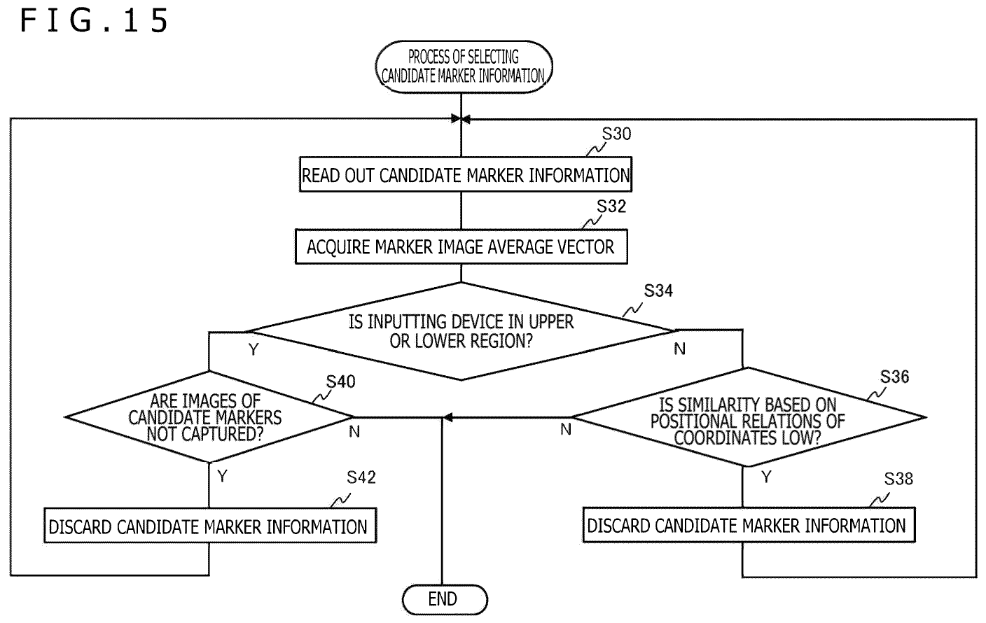

FIG. 15 is a flowchart depicting a processing procedure by which the position and posture derivation unit 226 selects candidate marker information in step S14 of FIG. 9. First, the position and posture derivation unit 226 reads out one of M pieces of candidate marker information retained by the candidate marker information retention unit 240 (S30). Next, the position and posture derivation unit 226 acquires a marker image average vector on the basis of N marker image coordinates extracted through steps S10 and S12 of FIG. 9 (S32).

Next, the position and posture derivation unit 226 checks whether or not the direction of the inputting device 16 indicated by the marker image average vector is in a range defined as the upper or lower region of the HMD 100 (S34). In a case where the inputting device 16 is not in the upper or lower region of the HMD 100 (N in S34), the position and posture derivation unit 226 compares a positional relation of a combination of candidate marker coordinates represented by the candidate marker information read out in step S30 and a positional relation of a combination of the marker image coordinates extracted through steps S10 and S12 of FIG. 9, to evaluate a similarity between them (S36).

In other words, the position and posture derivation unit 226 places the three-dimensional model of the inputting device 16 in a posture estimated on the basis of the sensor data and evaluates an apparent positional relation of the combination of the candidate marker coordinates and the positional relation of the marker image coordinates by, for example, orientations of obtuse angles formed by line segments each connecting adjacent coordinates. When the difference between them is equal to or greater than the reference, the position and posture derivation unit 226 determines that the similarity between the candidate markers and the marker image coordinates is low and the candidate marker information does not correspond to the marker image coordinates (Y in S36).

In this case, the position and posture derivation unit 226 discards the candidate marker information read out in step S30 (S38) and reads out new candidate marker information from the candidate marker information retention unit 240 (S30). In a case where the difference is smaller than the reference, the position and posture derivation unit 226 does not discard the candidate marker information and temporarily ends the selection process to use the candidate marker information for the processes S16 and S18 of FIG. 9 (N in S36).

In step S34, in a case where the inputting device 16 is in the upper or lower region of the HMD 100 (Y in S34), the position and posture derivation unit 226 evaluates the difference between the orientation of the surface of the three-dimensional model of the inputting device 16 on which the candidate markers are provided among the surfaces of the three-dimensional model and the orientation of the screen surface of a captured image to check whether or not images of the candidate markers can be captured in a captured image (S40). In other words, the position and posture derivation unit 226 acquires an angular difference between the marker image average vector and the candidate marker average vector, and in a case where the angular difference between them is equal to or smaller than a predetermined value, the position and posture derivation unit 226 determines that images of the candidate markers cannot be captured in a captured image (Y in S40).

In this case, the position and posture derivation unit 226 discards the candidate marker information read out in step S30 (S42) and reads out new candidate marker information from the candidate marker information retention unit 240 (S30). In a case where the position and posture derivation unit 226 determines that images of the candidate markers can be captured in a captured image, the position and posture derivation unit 226 does not discard the candidate marker information and temporarily ends the selection process to use the candidate marker information for the processes S16 and S18 of FIG. 9 (N in S40).

According to the present embodiment described above, position information and posture information of the inputting device are acquired by solving the PNP problem with use of an image of the inputting device captured in a captured image and the three-dimensional model of the inputting device. Here, as a preliminary step for calculating a re-projection error by making marker image coordinates on the captured image correspond to candidate markers on the three-dimensional model, the information processing apparatus uses posture information of the inputting device indicated by sensor data, to evaluate the appearance of the candidate markers and exclude, from a calculation target, candidate marker information that is highly unlikely to correspond to the marker image coordinates.

In order to specify candidate markers that do not correspond to the marker image coordinates, the information processing apparatus checks whether or not images of the candidate markers can be captured in a captured image, on the basis of the difference between the orientation of a surface of the three-dimensional model of the inputting device on which the candidate markers are provided among the surfaces of the three-dimensional model of the inputting device in a provisional posture based on sensor data and the orientation of the screen surface of the captured image. In a case where images of the candidate markers cannot be captured in a captured image, the candidate markers are excluded from a calculation target such that a calculation load can be reduced and position information and posture information can be acquired efficiently. Further, initially excluding the candidate markers that are unlikely to correspond to the marker images can reduce the possibility of incorrect correspondence in the calculation and increase the accuracy of the position information and the posture information.

Further, the information processing apparatus switches the rules for selecting candidate marker information, according to an actual state of the inputting device. Specifically, in a case where the inputting device is in a region defined as the upper or lower region of the HMD, candidate marker information is discarded or selected on the basis of whether or not images of candidate markers can be captured in a captured image as described above. In a case where the inputting device is in any other direction, the information processing apparatus compares a pattern formed by marker image coordinates with a pattern formed by the candidate markers and discards or selects the candidate marker information on the basis of a similarity between them. This minimizes the influence of errors included in a provisional posture of the three-dimensional model on the accuracy of the selection of the candidate marker information, regardless of the direction of the inputting device.

The present disclosure has been described above on the basis of the embodiment. The above-described embodiment is exemplary, and it can be recognized by those skilled in the art that various modifications can be made to combinations of the constituent components and processes and that such modifications also fall within the scope of the present disclosure. Although, in the embodiment, the estimation process is performed by the information processing apparatus 10, the functions of the information processing apparatus 10 may be provided in the HMD 100 such that the HMD 100 performs the estimation process.

While the arrangement of the plurality of markers in the inputting device 16, which includes the operation member 22, has been described in the embodiment above, the device that is a target of tracking may not necessarily include the operation member 22. Further, while the imaging apparatus 14 is attached to the HMD 100 in the embodiment, it is sufficient if the imaging apparatus 14 can capture marker images, and the imaging apparatus 14 may be attached to a different position other than the HMD 100.

What is claimed is:

1. An information processing apparatus comprising:
a captured image acquisition unit configured to acquire an image captured of a device that includes a plurality of markers;
an extraction unit configured to extract a marker image coordinate in the captured image;
a position and posture derivation unit configured to derive position information and posture information of the device from the extracted marker image coordinate and a three-dimensional coordinate of a candidate marker in a three-dimensional model of the device by performing a predetermined calculation; and
a sensor data acquisition unit configured to acquire data of a posture sensor of the device,
wherein the position and posture derivation unit places the three-dimensional model in a virtual three-dimensional space such that the three-dimensional model assumes a provisional posture of the device estimated using the data of the posture sensor, and discards or selects the candidate marker to be used for the calculation, on a basis of a difference between an orientation of a surface on which the candidate marker is provided among surfaces of the three-dimensional model and an orientation of a screen surface of the captured image.

2. The information processing apparatus according to claim 1, wherein the position and posture derivation unit evaluates the difference between the orientations by using an average vector of normal vectors of a plurality of the candidate markers and an average vector of vectors obtained by back-projecting a plurality of the marker image coordinates into the three-dimensional space and, in a case where an angular difference between the average vectors is equal to or smaller than a predetermined value, does not use the candidate markers for the calculation.

3. The information processing apparatus according to claim 1, wherein the position and posture derivation unit specifies a direction of the device with respect to an apparatus that captures the captured image, on a basis of the marker image coordinate and the orientation of the screen surface, and switches rules for discarding or selecting the candidate marker, according to the direction of the device.

4. The information processing apparatus according to claim 3, wherein, in a case where an angle of the device with respect to an axis in a gravity direction does not exceed a predetermined value, the position and posture derivation unit discards or selects the candidate marker on a basis of a rule based on the difference between the orientations of the surfaces.

5. The information processing apparatus according to claim 3, wherein, in a case where an angle of the device with respect to an axis in a gravity direction exceeds a predetermined value, the position and posture derivation unit discards or selects, on a basis of a similarity between a positional relation of a plurality of the marker image coordinates and a positional relation of three-dimensional coordinates of a plurality of the candidate markers viewed from the apparatus that captures the captured image, the candidate markers to be used for the calculation.

6. The information processing apparatus according to claim 5, wherein the position and posture derivation unit evaluates the similarity on a basis of an angular difference between a vector bisecting an obtuse angle formed by line segments each connecting adjacent marker image coordinates among the marker image coordinates and a vector bisecting an obtuse angle formed by line segments each connecting adjacent three-dimensional coordinates among the three-dimensional coordinates of the candidate markers and, in a case where the angular difference is equal to or greater than a predetermined value, does not use the candidate markers for the calculation.

7. A device information derivation method comprising:
acquiring an image captured of a device that includes a plurality of markers;
extracting a marker image coordinate in the captured image;
deriving position information and posture information of the device from the extracted marker image coordinate and a three-dimensional coordinate of a candidate marker in a three-dimensional model of the device by performing a predetermined calculation; and
acquiring data of a posture sensor of the device,
wherein the deriving the position information and the posture information includes placing the three-dimensional model in a virtual three-dimensional space such that the three-dimensional model assumes a provisional posture of the device estimated using the data of the posture sensor, and discarding or selecting the candidate marker to be used for the calculation, on a basis of a difference between an orientation of a surface on which the candidate marker is provided among surfaces of the three-dimensional model and an orientation of a screen surface of the captured image.

8. A computer program for a computer, comprising:
by a captured image acquisition unit, acquiring an image captured of a device that includes a plurality of markers;
by an extraction unit, extracting a marker image coordinate in the captured image;
by a position and posture derivation unit, deriving position information and posture information of the device from the extracted marker image coordinate and a three-dimensional coordinate of a candidate marker in a three-dimensional model of the device by performing a predetermined calculation; and
by a sensor data acquisition unit, acquiring data of a posture sensor of the device,
wherein the deriving the position information and the posture information includes placing the three-dimensional model in a virtual three-dimensional space such that the three-dimensional model assumes a provisional posture of the device estimated using the data of the posture sensor, and discarding or selecting the candidate marker to be used for the calculation, on a basis of a difference between an orientation of a surface on which the candidate marker is provided among surfaces of the three-dimensional model and an orientation of a screen surface of the captured image.
